(19) United States
(12) Patent Application Publication
(10) Pub. No.: US 2007/0023945 A1
(43) Pub. Date: Feb. 1, 2007

(54) Process for the manufacturing of an article made of plastic material

(75) Inventor: Anders Valentinsson, Farlov (SE)

Correspondence Address: STEVENS DAVIS MILLER & MOSHER, LLP, 1615 L STREET, NW, SUITE 850, WASHINGTON, DC, 20036, US

(73) Assignee: ARCA SYSTEMS AB, PERSTORP (SE)

(21) Appl. No.: 10/555,769

(22) PCT Filed: Apr. 26, 2004
(86) PCT No.: PCT/SE04/00634

§ 371 Date: Jul. 11, 2006

(30) Foreign Application Priority Data
May 8, 2003 (SE) 0301075-8

(51) Int. Cl. B29C 44/02

(52) U.S. Cl. 264/45.5

(57) ABSTRACT

A process for the manufacturing of an article made of plastic material, the article comprising an expanded foam filled core with an average density in the range 50-600 kg/m³ and a solid or semi solid outer skin with an average density above 700 kg/m³. The process comprises the steps of injecting a predetermined amount of molten thermoplastic material into the cavity of a closed mould, the thermoplastic material containing an expanding agent followed by allowing the thermoplastic material to solidify somewhat closest to the surface of the whereby a skin is formed. A first portion of the mould is then retracted while a second portion of the mould is retained in a closed position, whereby a volumetric increase of the mould cavity is achieved. The pressure in the mould hereby decreased allowing the expanding agent to expand the thermoplastic material. The molten thermoplastic material is then allowed to cool and solidify to a degree where the mould may be opened and the article is removed from the mould.

The present invention relates to process for achieving an article comprising a core of expanded plastic material and which at least partly includes solid or semi solid portions.

Articles made of plastic material with a heat insulating ability have been commonly known for a long time. One example of such an article are containers made of expanded thermoplastic styrene, so-called Styrofoam containers. These containers are excellent as heat insulators but have a very poor mechanical stability which will give them the characteristics of a disposable package. The surface of these containers is furthermore porous, which will make them rather difficult to keep clean. They are therefore less suited for use in the food supply industry.

Another type of articles made of plastic material is the rotation moulded plastic pallet. Initially a skin of solid thermoplastic material such as polyethylene or polypropylene is manufactured. The skin is after cooling filled with an expanded thermosetting polymer, most often polyurethane. Surf boards are also manufactured by this procedure. The reason for the use of expanded polymer is not the insulating effect in these cases, but the stabilising effect that will be obtained.

Yet another type of articles made of plastic material, are manufactured by blow moulding. These can be made twin-walled with an intermediate hollow space. Compost receptacles can be mentioned as an example of such articles. The hollow space can be filled with an expanded polymer if an increased heat insulating ability is desired. Normally a thermosetting material of polyurethane will be used.

One disadvantage with these processes is that the articles obtained will be impossible to recycle by material recovery since the materials used are not compatible. It is also difficult to provide the articles with well defined functional parts such as reinforcing profiles, guiding profiles, stacking profiles, hinge parts, pockets, label holders, profiles or holes for automatic handling, locking devices or the like, due to the coarse manufacturing tolerances allowed by these processes. It is therefore possible to use these processes for ordinary articles only since functions provided by functional parts as for example in a collapsible pallet container are impossible to manufacture.

It is desirable to achieve recyclable, heat insulating and rigid articles made of plastic material, that additionally are manufactured with the same accurate tolerance and functionality that can be achieved by traditional injection moulding.

It is possible to achieve the above mentioned desires according to the present invention, whereby a recyclable article made of plastic material, which article is provided with an even and dense surface, an insulating and/or stabilising inner layer and well defined functional parts, can be manufactured. Accordingly, the invention relates to a process for the manufacturing of an article made of thermoplastic material. The article comprises an expanded foam filled core with an average density in the range 50-650 kg/m³ and a solid or semi solid outer skin with an average density above 700 kg/m³. The invention is characterised in that the process comprises the steps of;

a) A predetermined amount of molten thermoplastic material is injected into the cavity of a closed mould. The thermoplastic material contains an expanding agent.

b) The thermoplastic material is then allowed to solidify somewhat closest to the surface of the mould for a predetermined amount of time so that a skin is formed.

c) A first portion of the mould is then retracted while a second portion of the mould is retained in a closed position. A volumetric increase of the mould cavity is hereby achieved and the pressure in the mould is decreased allowing the expanding agent of the thermoplastic material to expand the thermoplastic material in the parts of the mould where the first portion is retracted.

d) The molten thermoplastic material is then allowed to cool further and solidify to a degree where the mould may be opened and the article can be removed from the mould.

The article manufactured through the process is preferably selected from the group consisting of transport and storage articles. Such an article is may for example be a pallet, a pallet collar, a pallet container, a receptacle, a container, a crate, a compost receptacle, and a waste receptacle. These articles have portions comprised by expanded material given shape by the retracting, first portion of the mould. The second portion of the mould, retained in a closed position during the volumetric increase of the mould cavity, is used for giving shape to functional parts selected from the group consisting of reinforcing profiles, guiding profiles, stacking profiles, hinge parts, pockets, label holders, profiles and holes for automatic handling and locking devices. The second portion of the mould may further comprise collapsing mould members, allowing more complicated functional parts to be moulded.

The average density of a part of the article being formed by the second portion of the mould is preferably more than 1.5 times the density of a part of the article being formed by the first portion of the mould.

The process is further described together with enclosed figures showing one embodiment of the invention whereby,

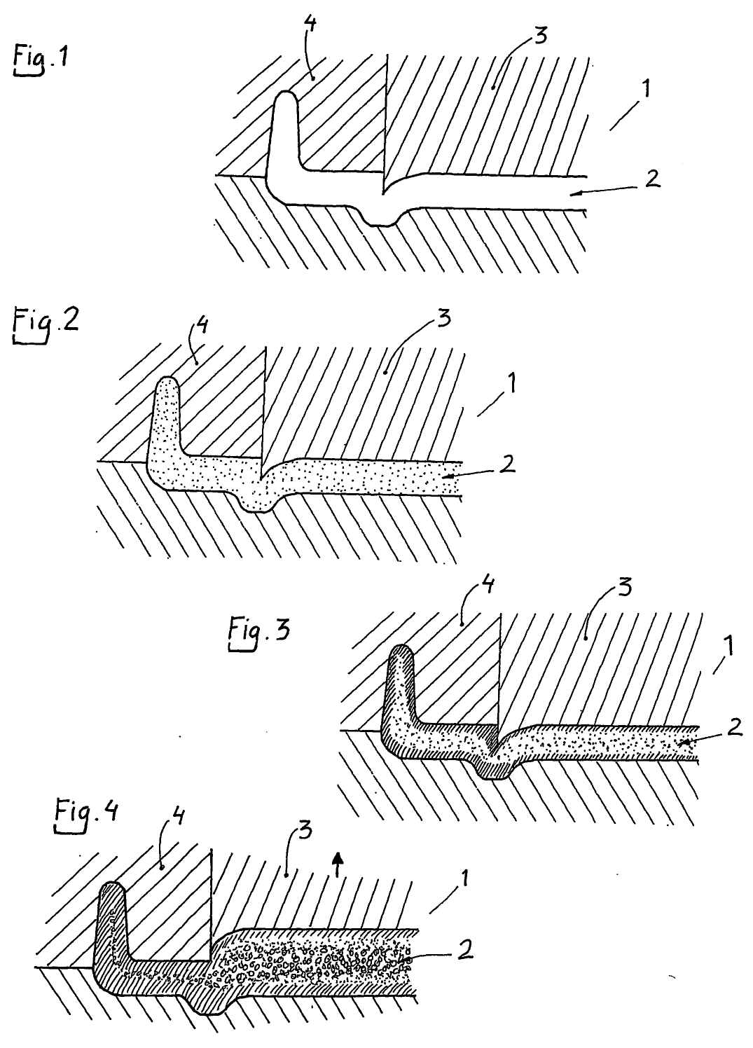

FIG. 1 shows in cross-section, parts of a closed mould 1 before injection of molten thermoplastic material.

FIG. 2 shows in cross-section, parts of the mould 1 of FIG. 1 during injection of thermoplastic material.

FIG. 3 shows in cross-section, parts of the mould 1 shown in FIGS. 1 and 2 during the formation of a skin of solid thermoplastic material.

FIG. 4 shows in cross-section, parts of the mould 1 shown in FIG. 1-3 during the retraction of the first mould member 3 allowing the thermoplastic material to expand.

Accordingly, FIG. 1 shows in cross-section, parts of a closed mould 1 before injection of molten thermoplastic material. The mould 1 comprises a mould cavity 2 which can be opened and closed for removal of articles produced herein. The mould 1 further comprises a first portion 3 which can be moved to increase the volume of the mould cavity 2. The mould 1 further comprises a second portion 4 which is retained in closed position during moving of the first portion 3. As shown in FIG. 2 a thermoplastic material comprising an expanding agent is injected into the mould cavity 2. The pressure in the mould 1 is kept at a level where a substantial expansion of the thermoplastic material is prohibited. In FIG. 3 the formation of a skin of solid thermoplastic material is shown. Once a predetermined skin depth is achieved a retraction of the first mould portion 3 as shown in FIG. 4 is commenced allowing the thermoplastic material to expand. It will hereby be possible to form an article with higher density in predetermined parts of the article. It is furthermore possible to guide, as well as increase, the density differences by using separate cooling systems in the mould 1. A section of the mould 1 which is cooler than other parts will locally achieve a faster and deeper formation of solid thermoplastic skin. Such a solidification will prevent expansion of the thermoplastic material in that that section of the mould 1.

These denser parts of the article are better suited to withstand certain forms of stress like point loads and also has greater resistance towards abrasion. Parts such as hinge pins and bearings, locking mechanisms and guiding wedges on foldable side walls, stacking ribs, lower parts of pallet skids and picking areas for pick and place robots serve as examples of part of articles which normally needs to be more dense than a standard expanded material.

The invention is not limited to the embodiment shown as it may be altered within the scope of the invention.

1. A process for the manufacturing of an article made of thermoplastic material, the article comprising an expanded foam filled core with an average density in the range 50-650 kg/m³ and a solid or semi solid outer skin with an average density above 700 kg/m³ wherein the process comprises the steps of;
a) injecting a predetermined amount of molten thermoplastic material into a cavity of a closed mould, the thermoplastic material containing an expanding agent, whereupon,
b) the thermoplastic material is allowed to solidify somewhat closest to the surface of the mould for a predetermined amount of time whereby a skin is formed, whereupon,
c) a first portion of the mould is retracted while a second portion of the mould is retained in a closed position, whereby a volumetric increase of the mould cavity is achieved and the pressure in the mould is decreased allowing the expanding agent of the thermoplastic material to expand the thermoplastic material in the parts of the mould where the first portion is retracted, whereupon,
d) the molten thermoplastic material is allowed to cool and solidify to a degree where the mould may be opened and the article is removed from the mould.

2. A process according to claim 1 wherein the article is selected from the group consisting of a transport and storage article.

3. A process according to claim 2 wherein the article is selected from the group consisting of a pallet, a pallet collar, a pallet container, a receptacle, a container, a crate, a compost receptacle, and a waste receptacle.

4. A process according to claim 1 wherein the second portion of the mould retained in a closed position during the volumetric increase of the mould cavity is used for giving shape to functional parts selected from the group consisting of reinforcing profiles, guiding profiles, stacking profiles, hinge parts, pockets, label holders, profiles and holes for automatic handling and locking devices.

5. A process according to claim 1 wherein the second portion of the mould further comprises collapsing mould members.

6. A process according to claim 1 wherein the average density of a part of the article being formed by the second portion of the mould is more than 1.5 times the density of a part of the article being formed by the first portion of the mould.
